(19) United States
(12) Patent Application Publication
(10) Pub. No.: US 2010/0190446 A1
(43) Pub. Date: Jul. 29, 2010

(54) PRINTER

(75) Inventor: Eiji Minami, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/695,058

(22) Filed: Jan. 27, 2010

(30) Foreign Application Priority Data
Jan. 28, 2009 (JP) 2009-017182

(51) Int. Cl. G06F 3/12; H04B 7/005

(52) U.S. Cl. 455/41.3; 358/1.15

(57) ABSTRACT

A printer includes a body, a print engine accommodated in the body, and a pair of antennae for near-field communication, the pair of antennae being provided on any one of front and rear surfaces, right and left surfaces, and upper and lower surfaces of the body, wherein in cases where a first antenna receives a radio signal related to a first print job, any one of the following is performed:
(1) performing all of the printing in accordance with the first print job with the print engine;
(2) performing part of the printing in accordance with the first print job with the print engine, followed by outputting a radio signal related to a remaining portion of the first print job from a second antenna other than the first antenna; and
(3) outputting a radio signal related to the first print job from the second antenna without performing printing in accordance with the first print job with the print engine.

### BACKGROUND

1. Technical Field

This application claims the benefit of Japanese Application No. 2009-017182, filed Jan. 28, 2009, all of which are hereby incorporated by reference.

The present invention relates to a printer having a plurality of antennae for near-field communication and more particularly to a technique for automatically performing distributed printing in a plurality of printers by using the near-field communication.

2. Related Art

In recent years, various products using near-field communication have been in practical use as represented by an automatic ticket checking system including a commuter ticket using an integrated circuit (IC) and an automatic ticket gate having an unit for reading the commuter ticket (see, for example, JP-A-2008-59098).

Meanwhile, it is expected that techniques of near-field communication will become widely applied to printing systems using a printer for individual users and office users. It is also expected that the application of the technique leads to development of a printing system having high efficiency and a simple configuration.

### SUMMARY

An advantage of some aspects of the invention is that it provides a printer using a technique of near-field communication in order to develop a printing system having high efficiency and a simple configuration.

According to an aspect of the invention, there is provided a printer having a body, a print engine accommodated in the body, and a pair of antennae for near-field communication provided on front and rear surfaces, right and left surfaces, or upper and lower surfaces of the body. In cases where a first antenna receives a radio signal related to a first print job, any one of following processes (1) to (3) is performed: (1) performing all of the printing in accordance with the first print job with the print engine; (2) performing part of the printing in accordance with the first print job with the print engine and outputting a radio signal related to a remaining portion of the first print job from a second antenna other than the first antenna; and (3) outputting a radio signal related to the first print job from the second antenna without performing printing in accordance with the first print job with the print engine.

It is preferable that the printer further includes a wired interface for connecting the printer to an information processor through a cable. In cases where the wired interface receives a second print job from the information processor, any one of following processes (4) to (6) may be performed: (4) performing all of the printing in accordance with the second print job with the print engine; (5) performing part of the printing in accordance with the second print job with the print engine and outputting a radio signal related to a remaining portion of the second print job from the second antenna; and (6) outputting a radio signal related to the second print job from the second antenna without performing printing in accordance with the second print job with the print engine.

It is preferable that in cases where the first antenna receives a radio signal related to the first print job or where the wired interface receives a radio signal related to the second print job, the print engine may perform all of the printing in accordance with the first or second print job when the printer is in the state in which printing can be performed, and the print engine may output a radio signal related to the first or second print job from the second antenna without performing printing in accordance with the first or second print job when the printer is not in the state in which printing can be performed.

It is preferable that in cases where a print request for printing many sets of a plurality of pages is included in the first or second print job, a set of the plurality of pages may be printed with the print engine, and a radio signal related to a print request for printing remaining sets of the plurality of pages may be output from the second antenna.

It is preferable that in cases where a print request for printing a plurality of pages is included in the first or second print job, some of the plurality of pages may be printed with the print engine, and radio signal related to a print request for printing remaining pages may be output from the second antenna.

It is preferable that the pair of antennae for near-field communication may be a coupler used for a Transfer Jet (Registered Trademark).

### BRIEF DESCRIPTION OF THE DRAWINGS

The invention will be described with reference to the accompanying drawings, wherein like numbers reference like elements.

FIG. 1 is a block diagram illustrating the configuration of a printing system according to an embodiment of the invention.

FIG. 2 is a block diagram illustrating the configuration of a printer according to an embodiment of the invention.

FIG. 3A is a diagram illustrating an example of the arrangement of printers which are each provided with a pair of couplers on front and rear surfaces of their body.

FIG. 3B is a diagram illustrating another example of the arrangement of printers which are each provided with a pair of couplers on upper and lower surfaces of their body.

FIG. 4 is a flowchart illustrating processing procedures in a printer.

### DESCRIPTION OF EXEMPLARY EMBODIMENTS

A printing system according to an embodiment of the invention will be described below with reference to the accompanying drawings.

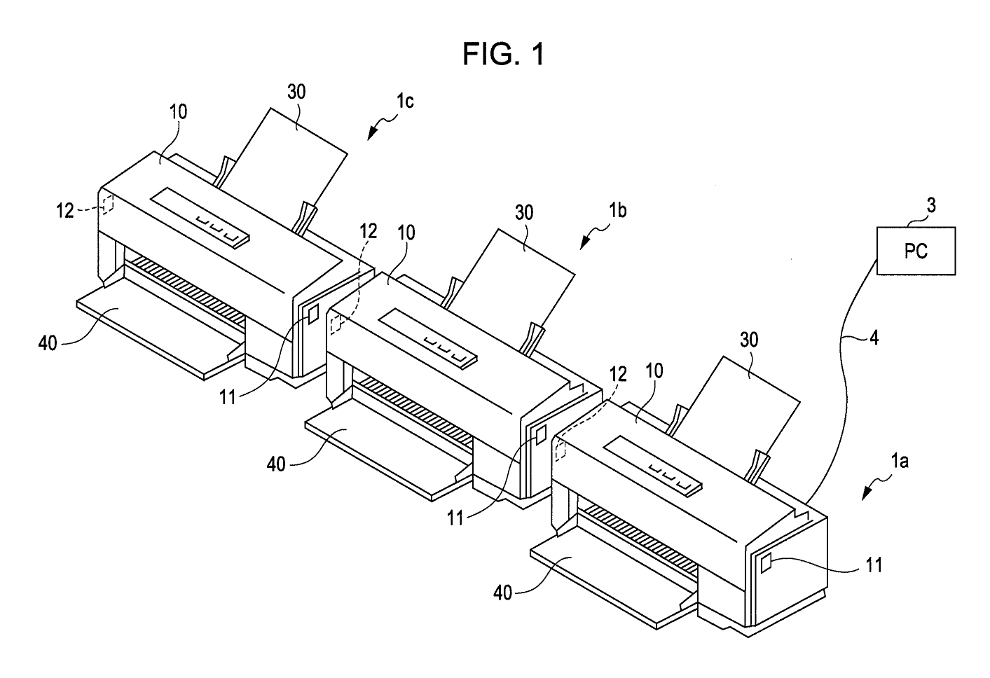

FIG. 1 is a block diagram illustrating the configuration of a printing system according to an embodiment of the invention.

With reference to FIG. 1, the system includes a plurality of printers (1a, 1b, 1c) each having the same configuration and a personal computer (PC) 3 serving as a host device.

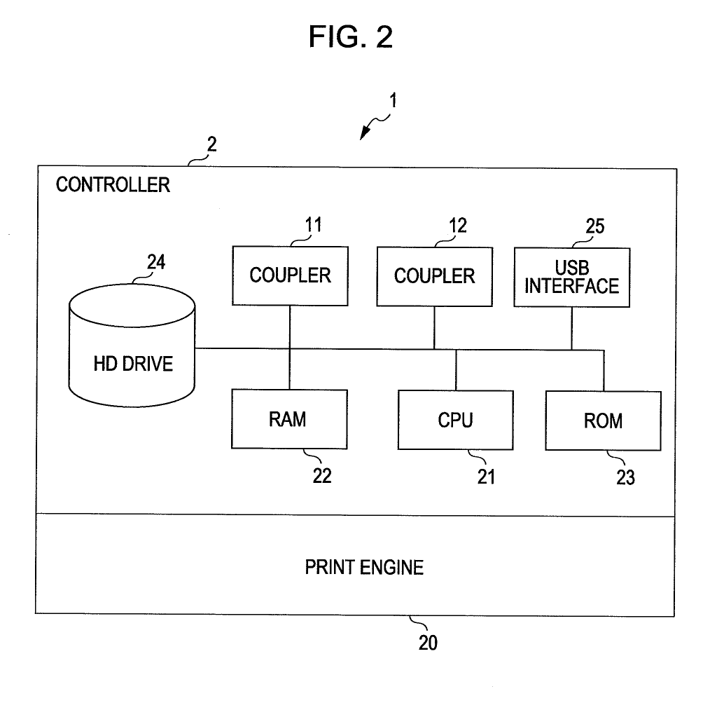

A printer 1 has a body 10 having a substantially rectangular parallelepiped shape. The body 10 is provided with a paper feed tray 30 at an upper portion of a back surface thereof and provided with an output tray 40 on a front surface thereof. A print engine 20 (see FIG. 2) accommodated in the body 10 performs printing on paper fed from the paper feed tray 30 and ejects the paper to the output tray 40.

In addition, the printer 1 includes antennae 11 and 12 for near-field communication. In this embodiment, Transfer Jet is used as an example of near-field communication. Accordingly, the antennae are referred to as couplers 11 and 12 hereinafter.

With reference to FIG. 1, the body 10 is provided with the coupler 11 on right side thereof and provided with the coupler 12 on left side thereof, and both couplers are located at the same height. Positions at which the couplers 11 and 12 are located may be the same in depth directions on the left and right sides. Accordingly, as shown in FIG. 1, in cases where the printers 1a, 1b, and 1c each having the same configuration are placed such that right sides of individual printers face left sides of other printers, couplers 11 and 12 among individual printers face each other.

The PC 3 is a general-purpose personal computer and connected to the printer 1 through a predetermined connection method [for example, universal serial bus (USB)]. The PC 3 sends a print job to the printer 1 to perform printing.

In this case, the PC 3 is connected to the printer 1a. A print job sent from the PC 3 to the printer 1a is processed in any one of the printers 1a, 1b, or 1c. Data are transmitted and received among the printers 1a to 1c through the couplers 11 and 12. In other words, in a configuration as shown in FIG. 1, data flows from the printer 1a of an upstream side to the printer 1c of a downstream side. The data transmission and reception will be described in detail hereinafter.

FIG. 2 is a block diagram illustrating the configuration of the printer 1.

With reference to FIG. 2, the printer 1 includes a controller 2 and a print engine 20. The controller 20 includes a central processing unit (CPU) 21, a random-access memory (RAM) 22, a read-only memory (ROM) 23, a hard disk (HD) drive 24 as a high-capacity memory unit, the couplers 11 and 12, and a USB interface 25. The coupler 11 and 12 are placed at positions described in FIG. 1 so as to be exposed from the body 10.

The CPU 21 executes a predetermined program stored in the ROM 23 or the HD drive 24 by utilizing the RAM 22 to perform each function of the printer 1 described below.

The USB interface 25 is an interface for connecting the PC 3 to the printer 1 through a USB cable 4. With reference to FIG. 1, only the printer 1a is connected to the PC 3.

In this embodiment, the coupler 11 (a first antenna) and the coupler 12 (a second antenna) form a pair. The coupler 11 of one printer 1 communicates with the coupler 12 of another printer 1. The coupler 12 of one printer 1 similarly communicates with the coupler 11 of another printer 1. In the example shown in FIG. 1, the coupler 12 of the printer 1a communicates with the coupler 11 of the printer 1b. The coupler 12 of the printer 1b similarly communicates with the coupler 11 of the printer 1c.

The printer 1 having the above configuration operates as described below. First, once the coupler 11 receives a radio signal related to a print job (a first print job), one of the following processes (1) to (3) is performed:
(1) The print engine 20 performs all of the printing in accordance with the print job.
(2) The print engine 20 performs part of the printing in accordance with the print job, and the coupler 12 outputs a radio signal related to a remaining portion of the print job.
(3) The print engine 20 does not perform printing in accordance with the print job, and a radio signal related to the print job is output from the coupler 12.

These correspond to, for example, the operation of the printer 1b shown in FIG. 1. In other words, in the printer 1b, the coupler 11 receives a print job from the coupler 12 of the printer 1a to perform any one of the processes (1) to (3). In this case, the USB interface 25 is not used in the printer 1b. Accordingly, in an embodiment such as the printer 1b which is not connected to the PC 3, the printer 1 may be configured without the USB interface 25.

Furthermore, in cases where the USB interface 25 receives a print job, the printer 1 operates as described below.

Accordingly, in cases where the USB interface 25 receives a print job (a second print job) from the PC 3, one of the following processes (4) to (6) is performed.
(4) The print engine 20 performs all of the printing in accordance with the print job.
(5) The print engine 20 performs part of the printing in accordance with the print job, and the coupler 12 outputs a radio signal related to a remaining portion of the print job.
(6) The print engine 20 does not perform printing in accordance with the print job, and a radio signal related to the print job is output from the coupler 12.

These correspond to, for example, the operation of the printer 1a shown in FIG. 1. In other words, in the printer 1a, the USB interface 25 receives a print job from the PC 3 to perform any one of the processes (4) to (6). In this case, the coupler 11 is not used in the printer 1a. Accordingly, in an example such as the most upstream printer 1a which is connected to the PC 3, the printer 1 may be configured without the coupler 11.

As described above, a print job is received by the coupler 11 or the USB interface 25 in the printer 1. At this time, in cases where the printer 1 can perform printing with the print engine 20, a print job is processed. In this process, all of the print jobs may be processed. On the other hand, in cases where a certain printer 1 cannot perform printing due to the printer 1 being in the process of performing other printing or due to the printer 1 having an error, a radio signal related to the received print job is output from the coupler 12 without the print job being processed, and then the coupler 11 of the adjacent printer 1 receives the signal. In other words, a print job which cannot be processed by the printer 1 is transferred to another printer of a downstream side, and then the printer of the downstream side processes the print job. In addition, with reference to FIG. 1, in cases where there are no printers on a downstream side as in the case of the printer 1c, for example, the printer 1c which is on the most downstream side processes all of the received print jobs.

In a printing system configured with the printer 1 according to the embodiment of the invention, a print job is received. In cases where the print job cannot be processed, the print job is transferred to an adjacent printer 1 through couplers to perform printing in the adjacent printer 1 or another printer 1 on a further downstream side. As a result, the print job can be efficiently processed.

In addition, in cases where a print job is processed in the printer 1 and where a print job includes a print request for printing many sets (many copies) of a plurality of pages, the printer 1 may print a set of the plurality of pages with the print engine 20. In this case, a radio signal related to a print job including a print request for printing the remaining sets (remaining copies) is output from the coupler 12 to be received by the coupler 11 of an adjacent printer 1.

By virtue of this advantage, a print job for printing a plurality of copies is distributed to a plurality of printers 1, so that the print job can be efficiently processed. Furthermore, because individual printers are placed adjacent to each other in the embodiment, users can retrieve output print materials at one place.

In addition, in cases where the print job is processed in the printer 1 and where a print job includes a print request for printing a plurality of pages (a print request for printing a plurality of pages more than a certain number of pages), the printer 1 may perform printing of some of the pages from the plurality of pages with the print engine 20. In this case, a radio signal related to a print job including a print request for printing remaining pages which have not printed yet is output from the coupler 12 to be received by the coupler 11 of the adjacent printer 1.

A print job for printing a plurality (a large quantities) of pages can be efficiently processed by virtue of this advantage. Furthermore, as in the case of printing a plurality of copies, because individual printers are placed adjacent to each other, users can retrieve output print materials at one place.

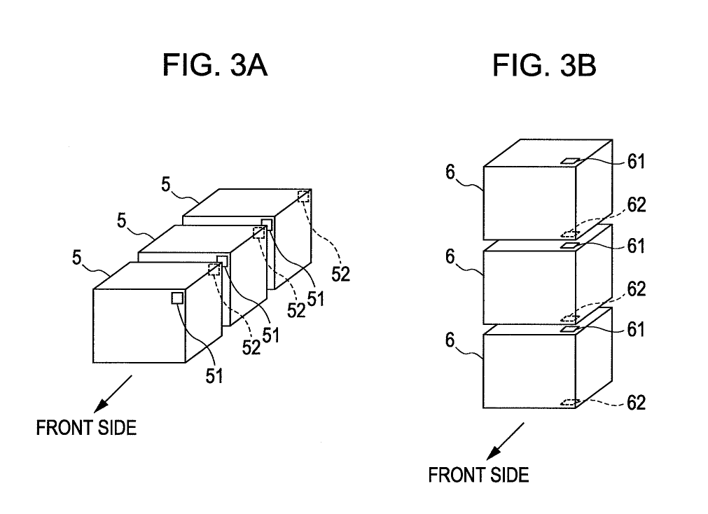

Although the above embodiments have been described in accordance with an example in which the body is provided with a pair of couplers on right and left sides thereof, the body may be provided with a pair of couplers on front and rear surfaces or upper and lower surfaces thereof. FIGS. 3A and 3B are diagrams schematically illustrating an example of the arrangement of printers 5 and 6. The printers 5 and 6 have the same configurations and functions as the printer 1 with the exception of differences in positions at which couplers are provided.

FIG. 3A illustrates an example of the arrangement of the printers 5 which are each provided with a pair of couplers 51 and 52 on front and rear surfaces of their body. In this case, the printers 5 are placed in a line in an anteroposterior direction, and individual printers 5 communicate with each other through opposed couplers 51 and 52. Likewise, FIG. 3B illustrates an example of the arrangement of the printers 6 which are each provided with a pair of couplers 61 and 62 on upper and lower surfaces of their body. In this case, the printers 6 are vertically placed in a line, and individual printers 6 communicate with each other through opposed couplers 61 and 62.

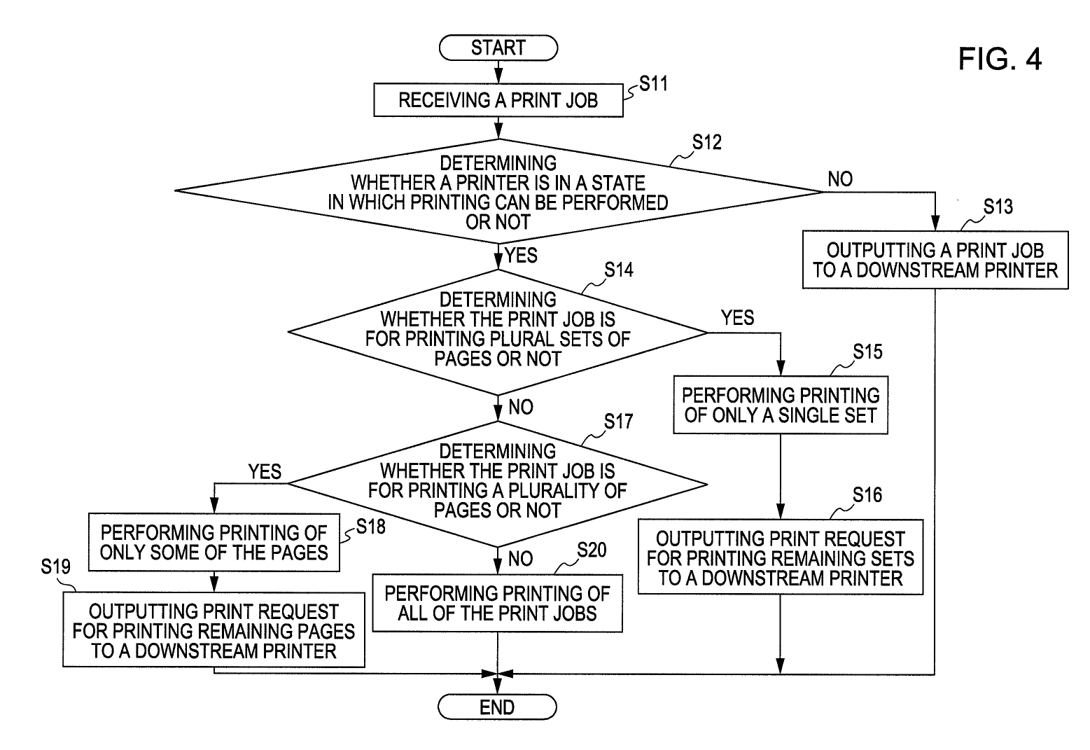

FIG. 4 is a flowchart illustrating processing procedures in the printer 1. The procedures will be described with reference to FIG. 4.

First, in the printer 1, the coupler 11 or the USB interface 25 receives a print job (S11).

In this process, the printer 1 determines whether the printer 1 is in the state in which printing can be performed or not (S12). In cases where it is determined that the printer 1 is not in the state in which printing can be performed (S12: No), all of the received print jobs are output from the coupler 12 and transferred to a downstream printer 1 (S13).

On the other hand, in cases where it is determined that the printer 1 is in the state in which printing can be performed (S12: Yes), the printer 1 determines whether the received print job is for printing plural sets of pages or not (S14). In this process, in cases where the print job is for printing a plurality of sets (S14: Yes), the printer 1 performs printing of only a single set (S15). A print job including remaining sets is output from the coupler 12 and transferred to the downstream printer 1 (S16).

In cases where the received print job is not for printing plural sets of pages (S14: No), it is determined whether the print job is for printing a plurality of pages more than a certain number of pages (10 pages, for example) or not (S17). In this process, in cases where the print job is for printing a plurality of pages more than a certain number of pages (S17: Yes), the printer 1 performs printing of some of the pages (for example, five pages) (S18). A print job including the residual pages is output from the coupler 12 and transferred to a downstream printer 1 (S19).

In cases where the print job is not for printing a plurality of pages more than a certain number of pages (S17: No), all of pages are printed in the printer 1 (S20).

The printer according to the embodiments can efficiently process a print job and can achieve a printing system having a simple configuration in which individual printers 1 are placed such that individual couplers face each other.

It should be understood that the embodiments of the invention are exemplary for the purpose of describing the invention and the scope of the invention is not limited to the embodiments. Those skilled in the art can practice the invention in various modifications thereof without departing from the scope of the invention.

For example, although an example of near-field communication using Transfer Jet is described in the embodiments, near-field communication using a technique other than Transfer jet, for example infrared communication, can be applied to the invention.

What is claimed is:

1. A printer comprising:
a body;
a print engine accommodated in the body; and
a pair of antennae for near-field communication, the pair of antennae being provided on any one of front and rear surfaces, right and left surfaces, and upper and lower surfaces of the body,
wherein in cases where a first antenna receives a radio signal related to a first print job, any one of the following is performed:
(1) performing all of the printing in accordance with the first print job with the print engine;
(2) performing part of the printing in accordance with the first print job with the print engine, followed by outputting a radio signal related to a remaining portion of the first print job from a second antenna other than the first antenna; and
(3) outputting a radio signal related to the first print job from the second antenna without performing printing in accordance with the first print job with the print engine.

2. The printer according to claim 1, further comprising:
a wired interface for connecting the printer to an information processor through a cable, wherein in cases where the wired interface receives a second print job from the information processor, any one of the following is performed:
(4) performing all of the printing in accordance with the second print job with the print engine;
(5) performing part of the printing in accordance with the second print job with the print engine, followed by outputting a radio signal related to a remaining portion of the second print job from the second antenna; and
(6) outputting a radio signal related to the second print job from the second antenna without performing printing in accordance with the second print job with the print engine.

3. The printer according to any one of claims 1, wherein, in any one of the cases where the first antenna receives a radio signal related to the first print job and where the wired interface receives a radio signal related to the second print job,
the print engine performs all of the printing in accordance with any one of the first and second print jobs when the printer is in the state in which printing can be performed, and
a radio signal related to any one of the first and second print jobs is output from the second antenna without performing printing in accordance with any one of the first and second print jobs with the print engine when the printer is not in the state in which printing can be performed.

4. The printer according to any one of claims 1, wherein in cases where a print request for printing many sets of a plurality of pages is included in any one of the first and second print jobs, a set of the plurality of pages is printed with the print engine, and then a radio signal related to a print request for printing remaining sets of the plurality of pages is output from the second antenna.

5. The printer according to any one of claims 1, wherein in cases where a print request for printing a plurality of pages is included in any one of the first and second print jobs, part of the plurality of pages is printed with the print engine, and then a radio signal related to a print request for printing remaining pages is output from the second antenna.

6. The printer according to claim 1, wherein the pair of antennae for near-field communication is a coupler used for Transfer Jet (Registered Trademark).
